(19) United States
(12) Patent Application Publication
(10) Pub. No.: US 2023/0088508 A1
(43) Pub. Date: Mar. 23, 2023

(54) MAGNETIC CUTTING BOARD

(71) Applicants: Joseph Steinman, Middletown, CA (US); John Q. Reinhardt, Middletown, CA (US)

(72) Inventors: Joseph Steinman, Middletown, CA (US); John Q. Reinhardt, Middletown, CA (US)

(21) Appl. No.: 17/478,794

(22) Filed: Sep. 17, 2021

(51) Int. Cl. A47J 47/00; A47G 21/14

(52) U.S. Cl. CPC A47J 47/005; A47G 21/14

(57) ABSTRACT

A magnetic cutting board is generally rectangular shaped having a top surface, a bottom surface, a front surface, a rear surface, a left surface, and a right surface. The rectangular cutting board comprised of a border portion and a cutting portion. A stack of magnets centrally positioned entirely within the rectangular cutting board are provided, wherein the stack of magnets are approximate to the left surface or the right surface and within the border portion. A magnetic blade of a knife is configured to be removably attached to the left surface or the right surface of the rectangular cutting board via the stack of magnets. The magnetic blade of the knife is not configured to be magnetically attached to the stack of magnets within the cutting portion of the rectangular cutting board.

### CROSS-REFERENCE TO RELATED APPLICATIONS

N/A

### BACKGROUND OF THE INVENTION

### 1. Field of the Invention

The present invention generally relates to food preparation safety but more particularly to a magnetic cutting board.

### 2. Description of Related Art

Cutting boards and butcher blocks are used for preparing food with sharp cutlery, such as knives. In-between use while preparing food on the cutting board, the knife is usually placed on the top surface of the cutting board, which may lead to injury from the knife accidently falling on the floor. Consequently, a solution is provided.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a magnetic cutting board is provided, comprising a rectangular cutting board having a top surface, a bottom surface, a front surface, a rear surface, a left surface, and a right surface; a first magnet positioned entirely within the rectangular cutting board at a first corner of a border of the rectangular cutting board, approximate to the right surface and the rear surface; and, wherein a magnetic blade of a knife is configured to be removably attached to the corner of the rectangular cutting board via the first magnet.

In one embodiment, a second magnet is provided and positioned entirely within the rectangular cutting board at a second corner of the border of the rectangular cutting board, approximate to the left surface and the front surface. In another embodiment, the first and second magnets are each comprised of a stack of magnets. In yet another embodiment, the stack of magnets consists essentially of a plurality of neodymium magnets. In one embodiment, the plurality of neodymium magnets are four rectangular shaped neodymium magnets. In one embodiment, the magnetic blade of the knife is configured to be parallel to the right surface when the magnetic blade of the knife is magnetically attached to the corner of the rectangular cutting board via the first magnet. In another embodiment, the magnetic blade of the knife is configured to be parallel to the top surface when the magnetic blade of the knife is magnetically attached to the corner of the rectangular cutting board via the first magnet. In one embodiment, the first magnet is centrally positioned between the top surface and the bottom surface. In another embodiment, the knife is configured to be off a counter surface when the magnetic blade of the knife is magnetically attached to the corner of the rectangular cutting board via the first magnet.

In another aspect of the invention, a magnetic cutting board is provided, comprising a rectangular cutting board having a top surface, a bottom surface, a front surface, a rear surface, a left surface, and a right surface; a magnet positioned entirely within the rectangular cutting board at a corner of a border of the rectangular cutting board; and, wherein a magnetic blade of a knife is configured to be removably attached to the corner of the rectangular cutting board via the magnet.

In one embodiment, the magnet is comprised of a stack of magnets. In another embodiment, the stack of magnets essentially consists of a plurality of neodymium magnets. In one embodiment, the plurality of neodymium magnets are four rectangular shaped neodymium magnets. In another embodiment, the first magnet is centrally positioned between the top surface and the bottom surface. In one embodiment, the border is a top left border approximate to the left surface and the rear surface. In another embodiment, the border is a top right border approximate to the right surface and the rear surface. In yet another embodiment, the border is a bottom left border approximate to the left surface and the front surface. In one embodiment, the border is a bottom right border approximate to the right surface and the front surface.

In yet another aspect of the invention, a magnetic cutting board is provided, comprising a rectangular cutting board having a top surface, a bottom surface, a front surface, a rear surface, a left surface, and a right surface; the rectangular cutting board comprised of a border portion and a cutting portion; a stack of magnets centrally positioned entirely within the rectangular cutting board, wherein the stack of magnets are approximate to the left surface or the right surface and within the border portion; wherein a magnetic blade of a knife is configured to be removably attached to the left surface or the right surface of the rectangular cutting board via the stack of magnets; and, wherein the magnetic blade of the knife is not configured to be magnetically attached to the stack of magnets within the cutting portion of the rectangular cutting board.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a magnetic cutting board with a knife magnetically attached to a side portion of the magnetic cutting board according to an embodiment of the present invention.

FIG. 2 is illustrates the magnetic cutting board of FIG. 1 with the magnet visible according to an embodiment of the present invention.

FIG. 3 is a sectional view of inside the magnetic cutting board showing the magnet's position according to an embodiment of the present invention.

FIG. 4 is an alternative magnetic cutting board with magnets visible according to an embodiment of the present invention.

FIG. 5 is a detailed view of a magnet according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a magnetic cutting board.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about” or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

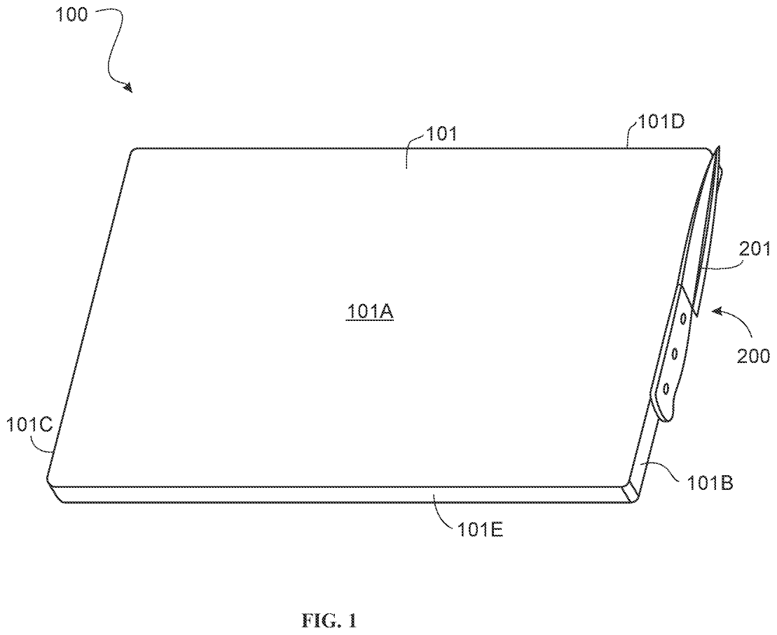

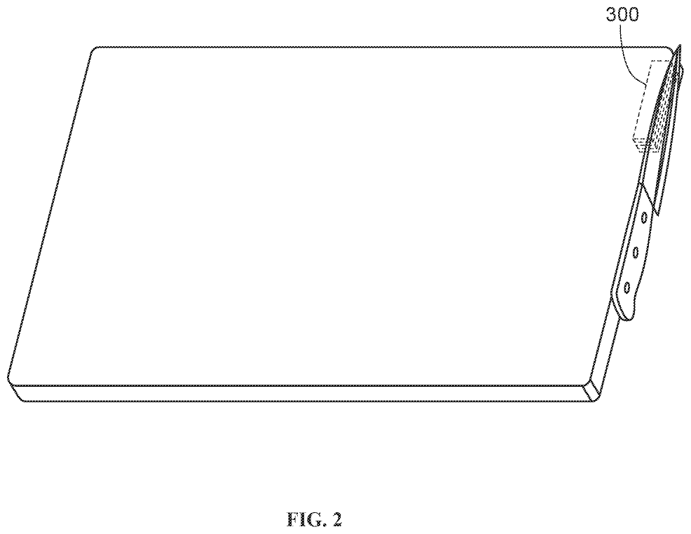

Referring now to any of the accompanying FIGS. 1-5, a magnetic cutting board 100 is illustrated. In one embodiment, the magnetic cutting board 100 comprises a top surface 101A, a bottom surface 101F, a front surface 101E, a rear surface 101D, a left surface 101C, and a right surface 101B. In one embodiment, the magnetic cutting board is rectangular shaped. In one embodiment, the rectangular shaped cutting board comprises a width that is longer than the length (as illustrated). In one embodiment, the rectangular shaped cutting board comprises a width equal to the length, such that the cutting board is square shaped. In alternative embodiments, the cutting board may be comprised of any shape known in the art, such as circle, diamond, triangular, hexagonal, or any polygon or irregular polygon. In one embodiment, the cutting board is constructed of wood, however other materials may be provided. It should be understood that the dimensions of the cutting board, such as the length, width, and thickness may vary.

In one embodiment, a magnet 300 is positioned entirely within the rectangular cutting board, such that no part of the magnet 300 is visible. In one embodiment, the magnet is centrally positioned between the top surface and the bottom surface. Advantageously, a magnetic blade 201 of a knife 200 is configured to be removably attached to a portion of the rectangular cutting board via the magnet 300. In one embodiment, the magnet is comprised of a stack of magnets (301A, 301B, 301C, 301D; FIG. 5), wherein the stack of magnets is neodymium magnets. In one embodiment, the neodymium magnets are rectangular or bar shaped. The number of neodymium magnets may vary, however it was determined that a stack of four neodymium magnets provide the desired magnetic field. The number of magnet stacks may vary, but generally there are two magnet stacks provided for each cutting board. This will be discussed in further detail below.

The location of the one or more magnet stacks may vary depending on if the user is right or left handed. In all embodiments, the magnet stacks are positioned in a corner location of the cutting board and within a border portion 310 of the cutting board, i.e. between a perimeter edge of the cutting board and the border portion 310. The remaining portion of the cutting board is considered the cutting portion, i.e. within the perimeter of the border portion 310 towards a central portion of the top surface of the cutting board.

For a right handed user, in one embodiment, a first stack of magnets 300A is positioned at a top right border corner location 311, approximate to the right surface 101B and the rear surface 101D. In one embodiment, the lengths of the rectangular neodymium magnets are parallel to the right and left surfaces of the cutting board. This location enables the knife 200 and specifically magnetic blade 201 to be magnetically attached to the right surface of the cutting board such that the entire blade is off the counter surface, defined as the surface in which the bottom surface of the cutting board is placed during use. Further, in this location the magnetic blade 201 may be magnetically attached such that the blade rests on the top surface in the cutting board.

The position of the first stack of magnets 300A within the defined border 310 is a critical aspect of the invention such that the magnetic blade of the knife is not configured to be magnetically attached to the stack of magnets within the cutting portion of the rectangular cutting board. It should be understood that the border may or may not be a visible aspect of the cutting board, but rather a defined location of a perimeter space where the magnets may be positioned. In other embodiments, the border portion of the cutting board is constructed differently than the cutting portion, and may have a visually distinguishing feature such that the user knows where the border is located. In some embodiments, the visually distinguishing feature of the border is helpful such that the user does not accidently cut produce, meat, etc. too close to where the magnets may be located which may causes unwanted magnet attraction between the magnets and the magnetic blade of the knife.

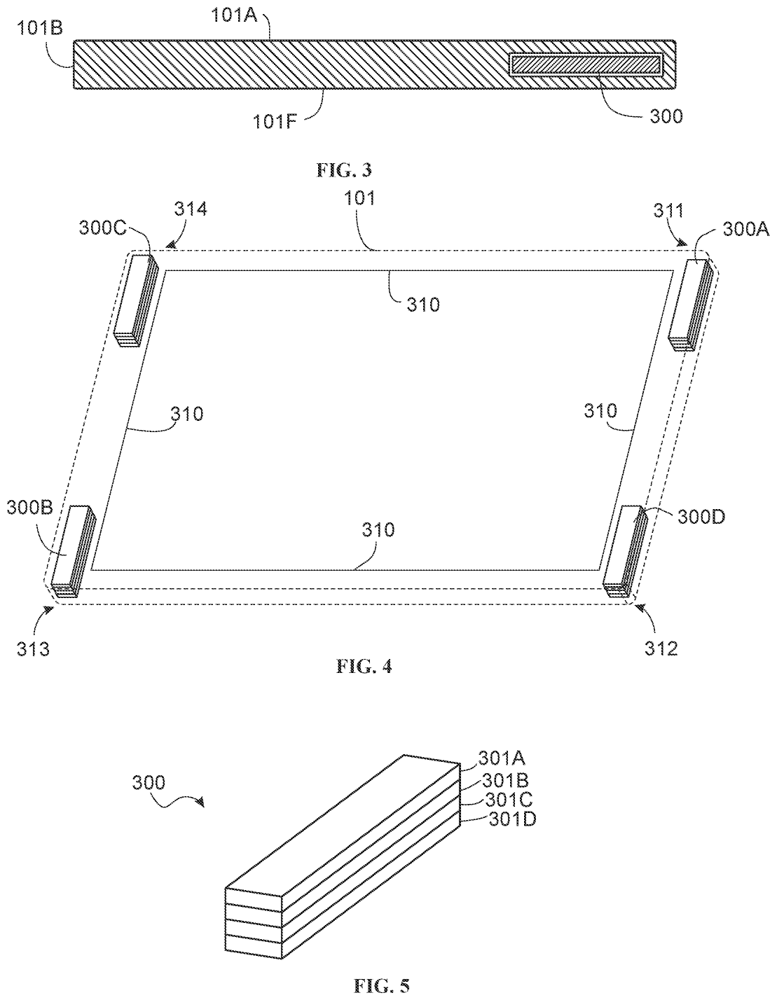

In one embodiment, during construction of the border portion of the cutting board, a portion is removed such that the magnet 300 may be positioned within the cutting board material (Best seen in FIG. 3). Then the border portion is attached to the cutting portion via a bonding technique, such as fasteners, adhesives, etc.

For a right handed user, in addition to the first stack of magnets 300A, a second stack of magnets 300B is provided, wherein the second stack of magnets 300B is positioned at a bottom left border corner location 313, approximate to the left surface 101C and the front surface 101E. Advantageously, wherein the first stack of magnets 300A and the second stack of magnets 300B are provided at the locations previously discussed, regardless of the orientation of the cutting board, when properly used, a magnet is always positioned in the top right corner of the board which is the preferred location for a right handed user to magnetically attach the knife to a side surface of the cutting board.

Likewise, for a left handed user, in one embodiment, two magnet stacks are preferred, wherein the two magnet stacks include a third stack of magnets 300C and a fourth stack of magnets 300D positioned in the top left border corner 314 and bottom right border corner 312 respectively. This enables a magnet, regardless of the orientation of the cutting board, when properly used, to be positioned in the top left corner of the board which is the preferred location for a left handed user to magnetically attach the knife to a side surface of the cutting board.

In yet another embodiment, the cutting board is configured to be reversible, such that the top surface may be flipped to be the bottom surface. In this embodiment, two stacks of magnets (300A and 300B) may be provided in the locations as previously discussed for a right handed user. Advantageously, when the cutting board is flipped, the magnets (300A and 300B) are positioned for a left handed user, such that (300A and 300B) are positioned where (300C and 300D) are illustrated.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A magnetic cutting board comprising:
a rectangular cutting board having a top surface, a bottom surface, a front surface, a rear surface, a left surface, and a right surface;
a first magnet positioned entirely within the rectangular cutting board at a first corner of a border of the rectangular cutting board, adjacent to the right surface and the rear surface, wherein the magnet is not visible; and,
wherein a magnetic blade of a knife is configured to be removably attached to the corner of the rectangular cutting board via the first magnet.

2. The magnetic cutting board of claim 1, further comprising a second magnet positioned entirely within the rectangular cutting board at a second corner of the border of the rectangular cutting board, adjacent to the left surface and the front surface.

3. The magnetic cutting board of claim 2, wherein the first and second magnets are each comprised of a stack of magnets.

4. The magnetic cutting board of claim 3, wherein the stack of magnets consists essentially of a plurality of neodymium magnets.

5. The magnetic cutting board of claim 4, wherein the plurality of neodymium magnets are four rectangular shaped neodymium magnets.

6. The magnetic cutting board of claim 1, wherein the magnetic blade of the knife is configured to be parallel to the right surface when the magnetic blade of the knife is magnetically attached to the corner of the rectangular cutting board via the first magnet.

7. The magnetic cutting board of claim 1, wherein the magnetic blade of the knife is configured to be parallel to the top surface when the magnetic blade of the knife is magnetically attached to the corner of the rectangular cutting board via the first magnet.

8. The magnetic cutting board of claim 1, wherein the first magnet is centrally positioned between the top surface and the bottom surface.

9. The magnetic cutting board of claim 1, wherein the knife is configured to be off a counter surface when the magnetic blade of the knife is magnetically attached to the corner of the rectangular cutting board via the first magnet.

10. A magnetic cutting board comprising:
a rectangular cutting board having a top surface, a bottom surface, a front surface, a rear surface, a left surface, and a right surface;
a magnet positioned entirely within the rectangular cutting board at a corner of the a border of the rectangular cutting board, wherein the magnet is not visible; and,
wherein a magnetic blade of a knife is configured to be removably attached to the corner of the rectangular cutting board via the magnet.

11. The magnetic cutting board of claim 10, wherein the magnet is comprised of a stack of magnets.

12. The magnetic cutting board of claim 11, wherein the stack of magnets consists essentially of a plurality of neodymium magnets.

13. The magnetic cutting board of claim 12, wherein the plurality of neodymium magnets are four rectangular shaped neodymium magnets.

14. The magnetic cutting board of claim 10, wherein the first magnet is centrally positioned between the top surface and the bottom surface.

15. The magnetic cutting board of claim 14, wherein the border is a top left border adjacent to the left surface and the rear surface.

16. The magnetic cutting board of claim 14, wherein the border is a top right border adjacent to the right surface and the rear surface.

17. The magnetic cutting board of claim 14, wherein the border is a bottom left border adjacent to the left surface and the front surface.

18. The magnetic cutting board of claim 14, wherein the border is a bottom right border adjacent to the right surface and the front surface.

19. A magnetic cutting board comprising:
a rectangular cutting board having a top surface, a bottom surface, a front surface, a rear surface, a left surface, and a right surface;
the rectangular cutting board comprised of a border portion and a cutting portion;
a stack of magnets centrally positioned entirely within the rectangular cutting board, wherein the stack of magnets are adjacent to the left surface or the right surface and within the border portion, wherein the stack of magnets are not visible;
wherein a magnetic blade of a knife is configured to be removably attached to the left surface or the right surface of the rectangular cutting board via the stack of magnets; and,
wherein the magnetic blade of the knife is not configured to be magnetically attached to the stack of magnets within the cutting portion of the rectangular cutting board.
